(19) United States
(12) Patent Application Publication
(10) Pub. No.: US 2025/0342358 A1
(43) Pub. Date: Nov. 6, 2025

(54) METHOD AND ELECTRONIC DEVICE WITH WEIGHT PRUNING

(71) Applicants: Samsung Electronics Co., Ltd., Suwon-si (KR); Research & Business Foundation SUNGKYUNKWAN UNIVERSITY, Suwon-si (KR)

(72) Inventors: Johnny RHE, Suwon-si (KR); Jong Hwan KO, Suwon-si (KR); Kangeun JEON, Suwon-si (KR)

(73) Assignees: Samsung Electronics Co., Ltd., Suwon-si (KR); Research & Business Foundation SUNGKYUNKWAN UNIVERSITY, Suwon-si (KR)

(21) Appl. No.: 19/069,410

(22) Filed: Mar. 4, 2025

(30) Foreign Application Priority Data
May 2, 2024 (KR) 10-2024-0058360

(51) Int. Cl. G06N 3/082

(52) U.S. Cl. CPC G06N 3/082

(57) ABSTRACT

A processor-implemented method includes determining a pattern entry set for skipping a target number of rows of a processing-in-memory (PIM) array in convolution operation, allocating each of one or more pattern entry types comprised in the pattern entry set to each of one or more input channels (ICs) of kernels comprised in a convolutional layer, determining a pruning score for each of one or more patterns associated with a corresponding pattern entry type allocated to the each of the one or more ICs, based on weights of the kernels, and determining a target pattern for the each of the one or more ICs based on the pruning score.

### CROSS-REFERENCE TO RELATED APPLICATIONS

This application claims the benefit under 35 USC § 119 (a) of Korean Patent Application No. 10-2024-0058360, filed on May 2, 2024 in the Korean Intellectual Property Office, the entire disclosure of which is incorporated herein by reference for all purposes.

### BACKGROUND

### 1. Field

The following description relates to a method and electronic device with weight pruning.

### 2. Description of Related Art

In processing-in-memory (PIM), a weight matrix of a convolutional neural network (CNN) may be compressed through pattern-based weight pruning. According to a shifted and duplicated kernel (SDK) mapping method designed to reuse input data, the inference accuracy of a CNN model, the number of rows for skipping convolution operation, and the compression rate of a weight matrix may vary depending on a pruning pattern.

A weight of each kernel of a convolutional layer may be appropriately trained to extract features of input data. When the same pattern is applied to all kernels without considering the importance of weights of kernels, the loss of inference accuracy may increase.

An SDK mapping method may map kernels corresponding to each of input channels in the row direction of a PIM array. The number of rows for skipping convolution operation may be determined by an entry of a pattern, so when the same pattern is applied to all kernels without distinction of the input channels, the number of skipping rows is the same for each input channel. As a result, the total number of rows to be skipped may be determined only by the number of input channels, so the compression rate of a weight matrix may be adjusted.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes determining a pattern entry set for skipping a target number of rows of a processing-in-memory (PIM) array in convolution operation, allocating each of one or more pattern entry types comprised in the pattern entry set to each of one or more input channels (ICs) of kernels comprised in a convolutional layer, determining a pruning score for each of one or more patterns associated with a corresponding pattern entry type allocated to the each of the one or more ICs, based on weights of the kernels, and determining a target pattern for the each of the one or more ICs based on the pruning score.

The determining of the pattern entry set for skipping the target number of rows of the PIM array may include determining a size of a parallel window of an input feature map, based on a size of a PIM array for convolution operation, a size of the kernels, and a size of the input feature map that is input to the convolutional layer, and determining the pattern entry set for minimizing weight pruning of the kernels based on the target number of rows to be skipped in the PIM array and the size of the parallel window.

The allocating of each of the one or more pattern entry types comprised in the pattern entry set to each of the one or more ICs of the kernels may include determining importance for the each of the one or more ICs of the kernels, based on the weights of the kernels, and allocating the each of the one or more pattern entry types to the each of the one or more ICs of the kernels, based on the importance.

A pattern entry type having few entries of the one or more pattern entry types is allocated to a channel with low importance among the one or more ICs.

A pattern entry type having many entries of the one or more pattern entry types is allocated to a channel with high importance among the one or more ICs.

The determining of the pruning score for each of the one or more patterns associated with the corresponding pattern entry type allocated to each of the one or more ICs, based on the weights of the kernels, may include, based on one or more patterns associated with a first pattern entry type allocated to a first IC among the one or more ICs, determining one or more pruned kernels by pruning weights of a first kernel corresponding to the first IC, and determining the pruning score for each of the one or more patterns associated with the first pattern entry type, based on weights of each of the one or more pruned kernels.

The determining of the target pattern for each of the one or more ICs based on the pruning score may include determining a pattern with a highest pruning score of the one or more patterns associated with the first pattern entry type to be a first target pattern of the first IC.

The one or more pattern entry types may include any one or any combination of any two or more of a 1-entry type, a 2-entry type, a 4-entry type, and an 8-entry type.

The one or more patterns associated with the corresponding pattern entry type has the same entry.

The method may include obtaining the convolutional layer of a pre-trained convolutional neural network (CNN) model.

The method may include determining one or more pruned kernels by pruning weights of one or more kernels corresponding to each of the one or more ICs, based on the target pattern, generating an output feature map by performing convolution operation between an input feature map and the one or more pruned kernels, and retraining the pre-trained CNN model based on the output feature map.

In one or more general aspects, a non-transitory computer-readable storage medium may store instructions that, when executed by one or more processors, configure the one or more processors to perform any one, any combination, or all of operations and/or methods disclosed herein.

In one or more general aspects, an electronic device includes one or more processors configured to determine a pattern entry set for skipping a target number of rows of a processing-in-memory (PIM) array in convolution operation, allocate each of one or more pattern entry types comprised in the pattern entry set to each of one or more input channels (ICs) of kernels comprised in a convolutional layer, determine a pruning score for each of one or more patterns associated with a corresponding pattern entry type allocated to the each of the one or more ICs, based on weights of the kernels, and determine a target pattern for the each of the one or more ICs based on the pruning score.

For the allocating of each of the one or more pattern entry types, the one or more processors may be configured to determine importance for the each of the one or more ICs of the kernels, based on the weights of the kernels, and allocate the each of the one or more pattern entry types to the each of the one or more ICs of the kernels, based on the importance.

A pattern entry type having few entries of the one or more pattern entry types may be allocated to a channel with low importance among the one or more ICs.

A pattern entry type having many entries of the one or more pattern entry types may be allocated to a channel with high importance among the one or more ICs.

For the determining of the pruning score for each of the one or more patterns, the one or more processors may be configured to, based on one or more patterns associated with a first pattern entry type allocated to a first IC among the one or more ICs, determine one or more pruned kernels by pruning weights of a first kernel corresponding to the first IC, and determine the pruning score for each of the one or more patterns associated with the first pattern entry type, based on weights of each of the one or more pruned kernels.

For the determining of the target pattern for each of the one or more ICs, the one or more processors may be configured to determine a pattern with a highest pruning score of the one or more patterns associated with a first pattern entry type to be a first target pattern of a first IC.

The one or more pattern entry types may include any one or any combination of any two or more of a 1-entry type, a 2-entry type, a 4-entry type, and an 8-entry type.

In one or more general aspects, a processor-implemented method includes determining pruned kernels by pruning weights of one or more kernels of an input channel (IC) of a convolutional layer, by applying a plurality of patterns of a pattern entry type to each of the one or more kernels, determining, for each of the patterns, a pruning score based on a sum of absolute values of elements of one or more of the pruned kernels corresponding to the respective pattern, determining, to be a target pattern of the IC, a pattern among the patterns with a highest pruning score among the pruning scores, and generating an output feature map by performing a convolution operation between an input feature map and the target pattern.

Other features and aspects will be apparent from the following detailed description, the drawings, and the claims.

### BRIEF DESCRIPTION OF THE DRAWINGS

FIG. 1 illustrates an example of a method of mapping weights to a processing-in-memory (PIM) array.

FIG. 2 illustrates an example of shifted and duplicated kernel (SDK) mapping.

FIG. 3 illustrates an example of an electronic device.

FIG. 4 illustrates an example of a pattern-based pruning method.

FIG. 5 illustrates an example of a pruned kernel based on an input channel-wise pattern entry type.

FIG. 6 illustrates an example of a pattern entry type.

FIG. 7 illustrates an example of a method of allocating a pattern entry type to an IC.

FIG. 8 illustrates an example of a method of determining a pruning score.

FIG. 9 illustrates an example of a pattern-based pruning method.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the state.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, should be construed to have meanings matching with contextual meanings in the relevant art and the disclosure of the present application, and are not to be construed to have an ideal or excessively formal meaning unless otherwise defined herein.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Hereinafter, examples will be described in detail with reference to the accompanying drawings. When describing the examples with reference to the accompanying drawings, like reference numerals refer to like components, and any repeated description related thereto will be omitted.

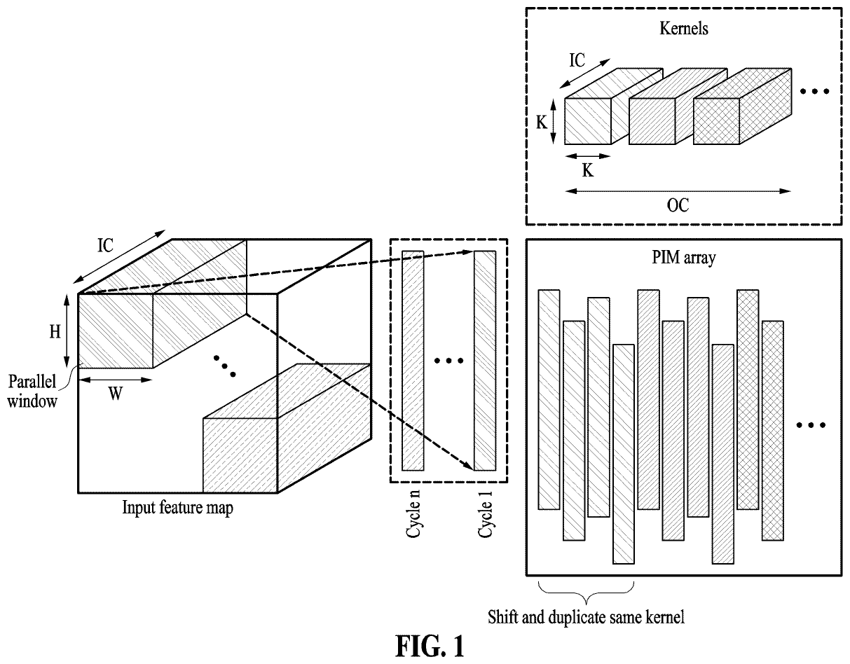

FIG. 1 illustrates an example of a method of mapping weights to a processing-in-memory (PIM) array.

A pruning method of one or more embodiments may use an optimal pattern that may flexibly adjust a compression rate of a weight matrix and increase an inference accuracy. A neural network model may correspond to a deep neural network (DNN) model including a plurality of layers. The plurality of layers may include an input layer, a hidden layer (e.g., one or more hidden layers), and an output layer. A neural network may include a fully connected network (FCN), a convolutional neural network (CNN), and/or a recurrent neural network (RNN).

In the case of a CNN, data input to each layer may be referred to as an input feature map and data output from each layer may be referred to as an output feature map. When a convolutional layer corresponds to an input layer, the input feature map of the input layer may be an input image.

In a convolutional layer of a CNN, a feature may be extracted through convolution operation between a kernel (or a filter) and the input feature map. The convolution operation may be performed while the kernel traverses pixel data of the input feature map at regular intervals. The kernel may include, for example, public parameters or weight parameters to search for features of the input feature map. The regular interval at which the kernel moves (or traverses) the pixel data of the input feature map may be referred to as a stride.

An operation of a CNN is performed multiple times using data in a memory, so the memory reuse rate is high. When the data input/output speed of the memory does not reach the operation speed of a processor, the overall system performance may be limited.

Processing-in-memory (PIM) may improve the overall system performance by allowing the memory to perform an operation in addition to the input/output and storage of data. In a CNN operation of a PIM method, weights of kernels may be mapped to a PIM array.

The convolutional layer may include at least one input channel (IC) each corresponding to at least one channel (i.e., the number of dimension(s)) of the input feature map and at least one output channel (OC).

The convolution operation may be performed using a kernel (or a kernel set) for each of ICs. For example, different kernels may be used for three ICs corresponding to each channel of the input feature map having three channels.

The convolution operation may be performed using a kernel (or a kernel set) for each of OCs. For example, different kernels may be used for five OCs in a convolutional layer having five OCs.

For example, when the shape of a kernel is (3×3×16), (3×3) may represent the size of the kernel and 16 may represent the number of ICs. When the shape of the kernel is (3×3×16×16), (3×3) may represent the size of the kernel and (16×16) may represent the number of ICs and OCs, respectively. That is, the size of the kernel is 3×3, and it may be seen that there is a kernel set including 16 input channel-wise kernels with respect to each of the 16 OCs of a convolutional layer.

In a CNN operation of a PIM method, weights of kernels corresponding to each of ICs may be mapped in the row direction of the PIM array and weights of kernels corresponding to each of OCs may be mapped in the column direction of the PIM array.

The input feature map may be input to the PIM array through a parallel window. While the parallel window traverses the input feature map at regular intervals for each cycle, pixel data filtered by the parallel window may be input to the PIM array.

For example, the parallel window may be a set of windows having the same size as a kernel. The parallel window may have a shape K×K×IC of the kernel. K×K×IC pieces of pixel data of the input feature map filtered by the parallel window may be input to each row of the PIM array. For each cycle, convolution operation may be performed between the pixel data of the input feature map that is input to the PIM array and a weight mapped to the PIM array. In this case, depending on the size of the PIM array or the size of the convolutional layer, a typical method and electronic device may create an unused memory area, and unnecessary energy consumption may occur.

Referring to FIG. 1, according to the shifted and duplicated kernel (SDK) mapping method that reuses the input feature map at a parallel window unit, the same (or duplicated) kernel may be mapped multiple times in the column direction that is adjacent to the PIM array.

The input feature map may be input to the PIM array through the parallel window having a size that is larger than the kernel. The parallel window may be a set of windows having a size that is larger than the kernel size. The parallel window may have a shape H×W×IC.

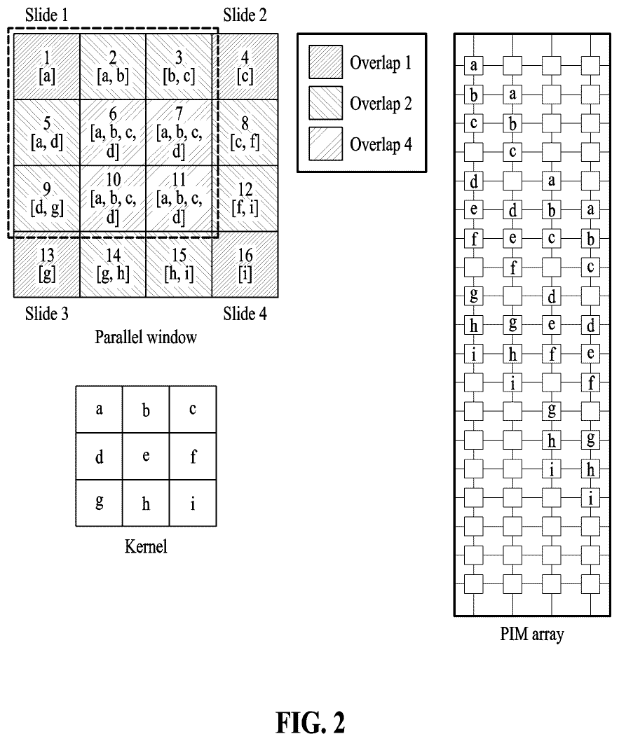

For each cycle, H×W×IC pieces of pixel data of the input feature map filtered by the parallel window may be input to each row of the PIM array, and convolution operation may be performed on duplicated kernel weights. This may be understood as convolution operation being performed for each part (slide) in which the kernel slides the parallel window at regular intervals. An example of SDK mapping is described with reference to FIG. 2.

FIG. 2 illustrates an example of SDK mapping.

As described above with reference to FIG. 1, according to the SDK mapping method, in a CNN operation, an input feature map may be input to a PIM array through a parallel window having a size that is larger than a kernel. The parallel window may be a set of windows having a size that is larger than the kernel size.

The parallel window may include slides, which are parts in which the kernel slides at regular intervals.

For example, referring to FIG. 2, the size of the kernel is (3×3) and the size of the parallel window is (4×4). The dashed box in the parallel window in FIG. 2 may represent slide 1 of the kernel size. When the kernel slides the parallel window at regular intervals by 1, the parallel window may include four slides (slide 1, slide 2, slide 3, and slide 4) with the kernel size.

The slides in the parallel window may include an overlapping area. Among pieces of pixel data of the input feature map filtered by the parallel window, pixel data corresponding to each element of the parallel window may be determined by the number of overlaps between slides.

According to the SDK mapping method, a duplicated kernel may be mapped to the PIM array multiple times in response to each slide of the parallel window. The duplicated kernel may be shifted in the row direction in response to each slide and may be mapped multiple times in the adjacent column direction.

For each cycle, 4×4×IC pieces of pixel data of the input feature map filtered by the parallel window may be input to each row of the PIM array, and convolution operation may be performed on a duplicated kernel weight mapped to the PIM array.

The present disclosure relates to a method of pruning weights of kernels based on a pattern during SDK mapping. By removing some of weight elements through weight pruning, a method and electronic device of one or more embodiments may reduce the size of a CNN model and reduce the amount of operations. In a CNN operation, by removing some of weight elements mapped to the PIM array through weight pruning, the method and electronic device of one or more embodiments may skip convolution operation of some rows to which a weight of the PIM array is not mapped.

Pattern-based pruning may be performed based on a pattern entry type having various entries. The entries may represent the number of weight elements that are not pruned. For example, when a kernel of a size (3×3) is pruned using a pattern of which a pattern entry type is a 4-entry type, 5 of 9 weight elements may be pruned and 4 weight elements may remain and be used for an operation.

There may be at least one pattern associated with one pattern entry type. When there is a plurality of patterns associated with one pattern entry type, each pattern may have a different shape with the same entry.

Depending on the different pattern shapes of the same entry, the number of pieces of row-skipping of the PIM array may vary, and the compression rate of the kernel may vary.

According to a typical SDK mapping method, there may be a weight element that is not pruned in a row of the PIM array due to irregular weight mapping. Thus, the typical SDK mapping method may have a problem of failing row-skipping of the PIM array and decreasing inference accuracy.

The weight of each kernel may be appropriately trained to extract a feature of the input feature map, but because the typical SDK mapping method prunes the weight without considering the importance of the weight, inference accuracy may decrease. Additionally, as the number of entries decreases in the typical SDK mapping method, inference accuracy may decrease.

In contrast to the typical SDK mapping method, a weight pruning method of one or more embodiments may improve inference accuracy by determining a pattern entry type based on the importance of a weight for each IC.

When the kernel weight corresponding to each of the ICs is mapped in the row direction of the PIM array, the number of pieces of row-skipping may be the same for each IC when the input channel-wise kernel is pruned using the same entry pattern. Accordingly, a typical weight pruning method may determine the total number of pieces of row-skipping for a pattern of a certain entry only by the number of ICs. Thus, the typical weight pruning method may have a problem in that the compression rate of the kernel weight may not be flexibly adjusted.

In contrast to the typical weight pruning method, the weight pruning method of one or more embodiments may flexibly adjust the compression rate of a kernel weight by determining a pattern entry type for each IC.

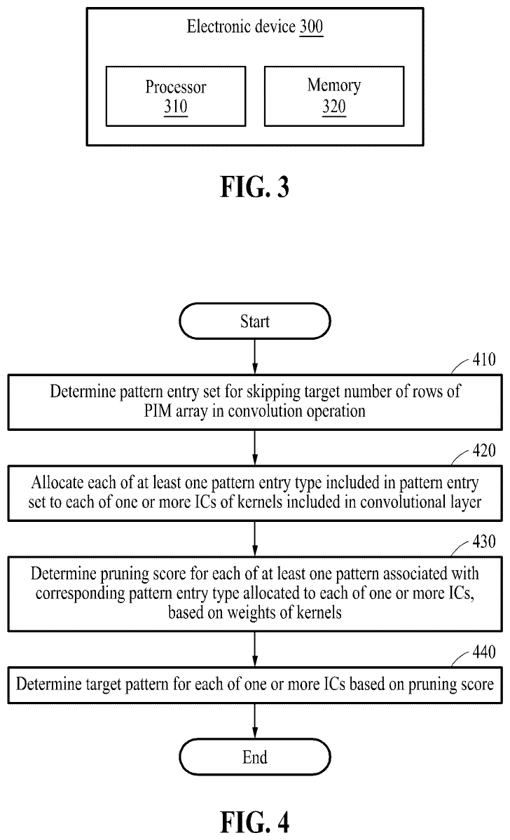

FIG. 3 illustrates an example of an electronic device.

An electronic device 300 may include a processor 310 (e.g., one or more processors) and a memory 320 (e.g., one or more memories) including one or more storage media configured to store instructions. For example, the electronic device 300 may be a system or a memory device that performs the PIM operation described above with reference to FIG. 1. The processor 310 may include at least one processor including a processing circuitry. The instructions, when executed individually or collectively by the processor 310, may cause the electronic device 300 to perform at least a portion of the operations described with reference to FIGS. 1 to 9.

The electronic device 300 may include a communicator connected to the processor 310 and the memory 320 to transmit and receive data therewith. The communicator may be connected to another external device and transmit and receive data to and from the external device. Hereinafter, transmitting and receiving “A” may refer to transmitting and receiving “information or data indicating A.”

The communicator may be implemented as circuitry in the electronic device 300. For example, the communicator may include an internal bus and an external bus. In another example, the communicator may be an element that connects the electronic device 300 to the external device. The communicator may be an interface. The communicator may receive data from the external device and transmit the data to the processor 310 and the memory 320.

The processor 310 may process data received from the communicator and data stored in the memory 320. The “processor” may be a data processing device implemented by hardware including a circuit having a physical structure to perform desired operations. For example, the desired operations may include code or instructions in a program. For example, the hardware-implemented data processing device may include a microprocessor, a central processing unit (CPU), a graphics processing unit (GPU), a processor core, a multi-core processor, a multiprocessor, an application-specific integrated circuit (ASIC), and a field-programmable gate array (FPGA).

The processor 310 may control other components (e.g., a hardware or software component) of the electronic device 300 and may perform various types of data processing or operations. As at least a part of data processing or operations, the processor 310 may store instructions or data received from another component (e.g., the communicator) in the memory 320, process the instructions or the data stored in the memory 320, and store result data in the memory 320. Operations performed by the processor 310 may be substantially the same as the operations of the electronic device 300.

The memory 320 may store information that is necessary for the processor 310 to perform the processing operation. The memory 320 (or one or more storage media included in the memory 320) may store instructions executed by the processor 310 and may store related information while software and/or a program is being executed by the electronic device 300. For example, the memory 320 may include a non-transitory computer-readable storage medium storing instructions that, when executed by the processor 310, configure the processor 310 to perform any one, any combination, or all of operations and/or methods disclosed herein with reference to FIGS. 1-9. The memory 320 may store at least one pattern associated with a predetermined pattern entry type. The memory 320 may store a convolutional layer of a pre-trained CNN model.

For example, the memory 320 may be a volatile memory and/or a non-volatile memory known in the art, such as random-access memory (RAM), dynamic RAM (DRAM), static RAM (SRAM), non-volatile RAM (NVRAM), persistent memory (PMEM), magneto-resistive RAM (MRAM), and/or high-bandwidth memory (HBM).

The electronic device 300 may be connected to an external memory through the communicator. For example, the electronic device 300 may include at least one volatile memory, non-volatile memory, RAM, flash memory, a hard disk drive, and/or an optical disk drive. The external memory may store an instruction set (e.g., software) for operating the electronic device 300. The instruction set for operating the electronic device 300 may be executed by the processor 310.

FIG. 4 illustrates an example of a pattern-based pruning method.

Operations 410 to 440 to be described hereinafter may be performed sequentially in the order and manner as shown and described below with reference to FIG. 4, but the order of one or more of the operations may be changed, one or more of the operations may be omitted, and two or more of the operations may be performed in parallel or simultaneously without departing from the spirit and scope of the example embodiments described herein. Operations 410 to 440 below may be performed by an electronic device (e.g., the electronic device 300 of FIG. 3). For example, the electronic device may include at least one processor (e.g., the processor 310 of FIG. 3) and a memory (e.g., the memory 320 of FIG. 3).

The electronic device may obtain a convolutional layer of a pre-trained CNN model. In an example, the memory of the electronic device may store the convolutional layer of the pre-trained CNN model. In another example, the electronic device may receive the convolutional layer of the pre-trained CNN model from an external electronic device or a server.

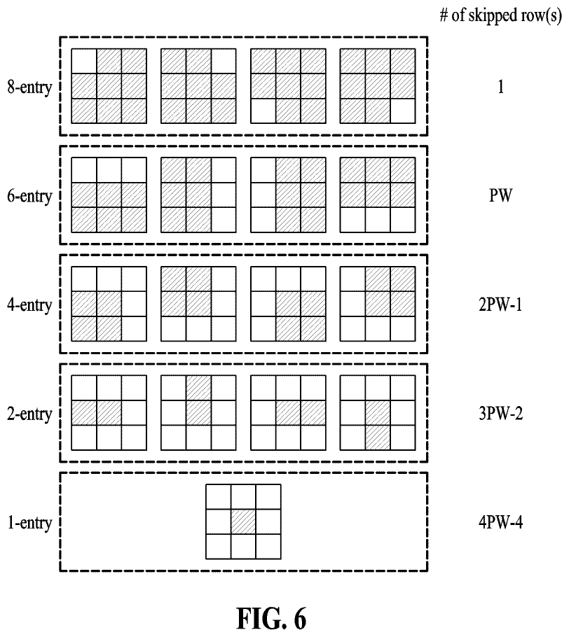

The electronic device may obtain at least one pattern associated with a predetermined pattern entry type. In an example, the memory of the electronic device may store the at least one pattern associated with the predetermined pattern entry type. In another example, the electronic device may receive the at least one pattern associated with the predetermined pattern entry type from the external electronic device or the server. An example of the predetermined pattern entry type is described in detail below with reference to FIG. 6.

In operation 410, the electronic device may determine a pattern entry set for skipping the target number of rows of a PIM array in convolution operation.

In the convolution operation, the target number of skipping rows of the PIM array may be predetermined or input by a user. The target number may be changed or adjusted.

The electronic device may determine the size of a parallel window based on the size of the PIM array for the convolution operation, the size of kernels, and the size of an input feature map that is input to the convolutional layer.

Based on the size of the PIM array, the size of the kernels, and the size of the input feature map, the electronic device may determine the number of shifts of the parallel window, the number of times data of the input feature map is input to the PIM array through the parallel window, and the number of times data of an output feature map is output from the PIM array. The electronic device may determine the number of cycles of the PIM array for the convolutional layer based on at least one of the number of shifts, the number of inputs, or the number of outputs. Each cycle may be a process in which pixel data of the input feature map filtered by the parallel window is input to the PIM array, and data on which the convolution operation is performed is output from the PIM array. The electronic device may determine the size of the parallel window such that the number of cycles is minimized.

The electronic device may determine the pattern entry set for minimizing weight pruning of the kernels based on the target number of rows to be skipped in the PIM array and the size of the parallel window.

When a kernel weight is pruned by a pattern of a certain pattern entry type, the number of skipping rows may be determined according to the size of the parallel window. An example of the number of skipping rows corresponding to each pattern entry type is described with reference to FIG. 6.

There may be several cases for a combination of pattern entry types in skipping the target number of rows. For example, when the size of the parallel window is (4×4), for skipping 10 rows, 10 patterns of an 8-entry type may be used, or 1 pattern of a 4-entry type and 3 patterns of an 8-entry type may also be used.

Using a genetic algorithm (GA) model, the electronic device may determine the pattern entry set including an optimal combination of several possible combinations of pattern entry types that may be used for skipping the target number of rows. The GA model may be pre-trained to determine the pattern entry set that may least prune weight elements of the kernels for skipping the target number of rows, based on the target number and the size of the parallel window. The inference accuracy of a CNN may be improved by minimizing the number of weight elements to be pruned.

The pattern entry set may include at least one pattern entry type. The at least one pattern entry type may include at least one of a 1-entry type, a 2-entry type, a 4-entry type, and/or an 8-entry type.

In operation 420, the electronic device may allocate each of the at least one pattern entry type included in the pattern entry set to each of one or more ICs of the kernels included in the convolutional layer.

The electronic device may determine the importance of each of the one or more ICs of the kernels, based on weights of the kernels.

The electronic device may allocate each of the at least one pattern entry type to each of the one or more ICs of the kernels, based on the importance.

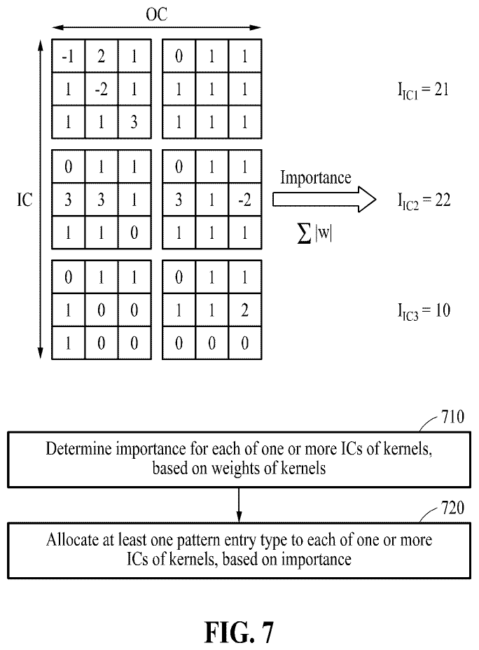

An example of a method of allocating a pattern entry type to an IC is described in detail below with reference to FIG. 7.

In operation 430, the electronic device may determine a pruning score for each of the at least one pattern associated with a corresponding pattern entry type allocated to each of the one or more ICs, based on the weights of the kernels.

At least one pattern associated with a certain pattern entry type may have the same entry.

Based on at least one pattern associated with a first pattern entry type allocated to a first IC among the one or more ICs, the electronic device may determine at least one pruned kernel by pruning weights of a first kernel corresponding to the first IC.

The electronic device may determine a pruning score for each of the at least one pattern associated with the first pattern entry type, based on weights of each of the at least one pruned kernel.

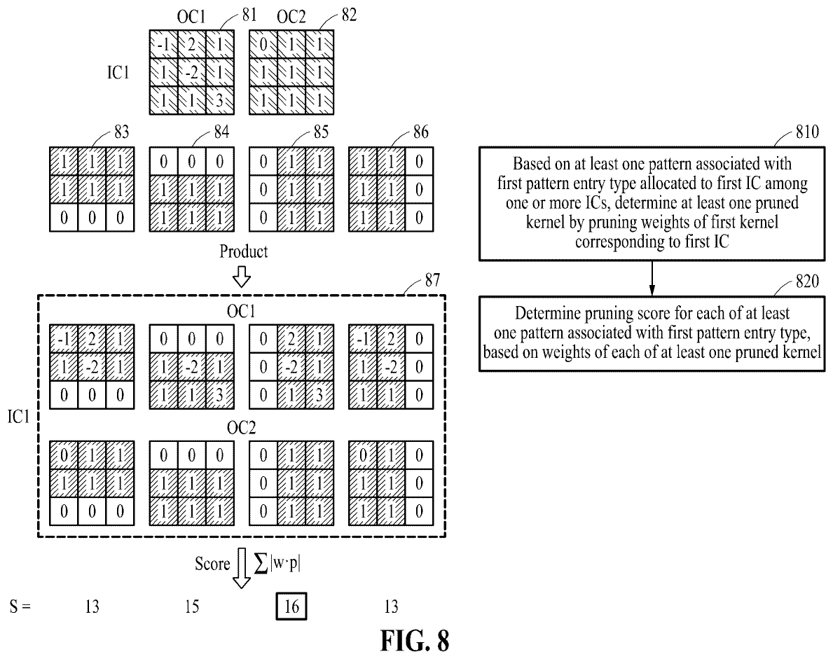

An example of a method of determining a pruning score is described in detail below with reference to FIG. 8.

In operation 440, the electronic device may determine a target pattern for each of the one or more ICs based on the pruning score.

In operation 440, the electronic device may determine a pattern having the highest pruning score of the at least one pattern associated with the first pattern entry type to be a first target pattern of the first IC.

In operation 440, the electronic device may determine one or more pruned kernels by pruning weights of at least one kernel corresponding to each of the one or more ICs, based on the target pattern.

In operation 440, the electronic device may obtain an output feature map by performing convolution operation between the input feature map and the one or more pruned kernels. In operation 440, the electronic device may retrain the pre-trained CNN model based on the output feature map.

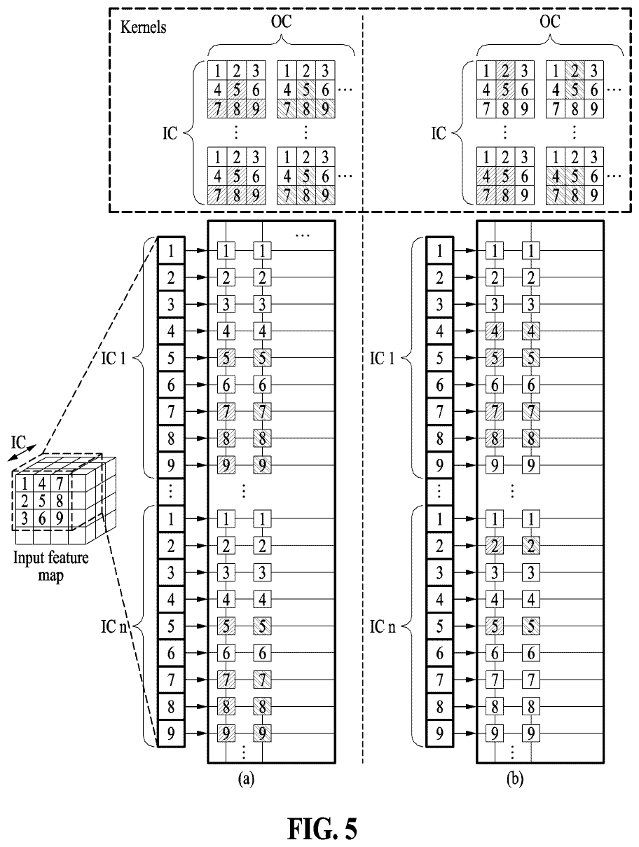

FIG. 5 illustrates an example of a pruned kernel based on an input channel-wise pattern entry type.

In a CNN operation of a PIM method, weights of kernels corresponding to each of ICs may be mapped in the row direction of a PIM array and weights of kernels corresponding to each of OCs may be mapped in the column direction of the PIM array.

According to the SDK mapping method, the same (or duplicated) kernel may be mapped multiple times in the column direction that is adjacent to the PIM array. For ease of description, a diagram illustrating mapping of duplicated kernels is omitted from FIG. 5.

Referring to (a) of FIG. 5, kernels corresponding to each of one or more ICs may be pruned based on the same pattern entry type. In this case, the number of pieces of row-skipping for each of the one or more ICs may be the same. Accordingly, the typical weight pruning method may determine the total number of pieces of row-skipping only by the number of ICs. Thus, a problem may arise in the typical weight pruning method in which the compression rate of a kernel weight may not be flexibly adjusted.

In contrast to the typical weight pruning method, the weight pruning method of one or more embodiments may flexibly adjust the compression rate of the kernel weight by determining a pattern entry type for each IC.

Referring to (b) of FIG. 5, the kernels corresponding to each of the one or more ICs may be pruned based on different pattern entry types. The importance of each of the one or more ICs of the kernels may be determined based on weights of the kernels, and at least one pattern entry type may be allocated to each of the one or more ICs of the kernel based on the importance.

FIG. 6 illustrates an example of a pattern entry type.

An electronic device (e.g., the electronic device 300 of FIG. 3) may store at least one pattern associated with a predetermined pattern entry type.

Pattern-based pruning may be performed based on a pattern entry type having various entries. The entries may represent the number of weight elements that are not to be pruned. For example, when a kernel of a size (3×3) is pruned using a pattern of which a pattern entry type is a 4-entry type, 5 of 9 weight elements may be pruned and 4 weight elements may remain and be used for an operation.

Referring to FIG. 6, the white block of each pattern may have a value of 0 as index for pruning the weight elements, and the other blocks may have a value of 1 as index for not pruning the weight elements.

PW may represent the height (or the width) of a parallel window, that is, the size of the parallel window. When the kernel weight is pruned based on a pattern of each pattern entry type, in a CNN operation, the number of skipping rows of a PIM array may be determined by PW or may always be 1 (e.g., for an 8-entry type).

The efficiency of the weight pruning may be determined by (the number of skipping rows)/(the number of pruned weight elements). That is, when a ratio of the number of skipping rows to the number of weight elements to be pruned is high, many rows may be skipped with less pruning, which may increase efficiency.

In the present disclosure, the pattern entry type may include a 1-entry type, a 2-entry type, a 4-entry type, and an 8-entry type. A 3-entry type and a 5-entry type with low-weight pruning efficiency may be excluded from the pattern entry type. The efficiency of a 7-entry type and an 8-entry type is the same, but the 8-entry type may be used to precisely control the number of skipping rows.

FIG. 7 illustrates an example of a method of allocating a pattern entry type to an IC.

Operations 710 to 720 to be described hereinafter may be performed sequentially in the order and manner as shown and described below with reference to FIG. 7, but the order of one or more of the operations may be changed, one or more of the operations may be omitted, and two or more of the operations may be performed in parallel or simultaneously without departing from the spirit and scope of the example embodiments described herein.

Operations 710 and 720 below may be performed by an electronic device (e.g., the electronic device 300 of FIG. 3). For example, the electronic device may include at least one processor (e.g., the processor 310 of FIG. 3) and a memory (e.g., the memory 320 of FIG. 3). Operation 420 of FIG. 4 may include operations 710 and 720 below.

In operation 710, the electronic device may determine the importance for each of one or more ICs of kernels, based on weights of the kernels.

The electronic device may determine importance/through Equation 1 below, for example.

$${l}_{IC} = {\sum }_{j = 0}^{Output channel} {\sum }_{i = 0}^{{k}^{2}} \vert {W}_{( i , j )} \vert \qquad Equation 1$$

In Equation 1, I_{IC} denotes the importance of each IC, W denotes weight elements of the kernels, and k denotes a size k×k of the kernels.

For example, referring to FIG. 7, a convolutional layer may include three ICs IC1, IC2, and IC3 respectively corresponding to channels of an input feature map and two OCs OC1 and OC2. Importance I_{IC1}, I_{IC2}, and I_{IC3} for each of the ICs may be determined as the sum of the absolute values of the weight elements of the kernels corresponding to each of the ICs. Accordingly, the electronic device may determine that I_{IC1} may be 21 (i.e., I_{IC1}=21), I_{IC2} may be 22 (i.e., I_{IC2}=22), and I_{IC3} may be 10 (i.e., I_{IC3}=10).

In operation 720, the electronic device may allocate at least one pattern entry type included in a pattern entry set to each of the one or more ICs of the kernels, based on the importance.

The electronic device may allocate a pattern entry type having few entries of the at least one pattern entry type to a channel with less importance among the one or more ICs.

The electronic device may allocate a pattern entry type having many entries of the at least one pattern entry type to a channel with high importance among the one or more ICs.

For example, the pattern entry set may include a 6-entry type, an 8-entry type, and a 4-entry type. The electronic device may allocate a 4-entry type having the fewest entries to the IC3 with the least important among the ICs IC1, IC2, and IC3, allocate an 8-entry type having the most entries to the IC2 with the highest importance, and allocate a 6-entry type to the IC1.

FIG. 8 illustrates an example of a method of determining a pruning score. Operations 810 to 820 to be described hereinafter may be performed sequentially in the order and manner as shown and described below with reference to FIG. 8, but the order of one or more of the operations may be changed, one or more of the operations may be omitted, and two or more of the operations may be performed in parallel or simultaneously without departing from the spirit and scope of the example embodiments described herein.

Operations 810 and 820 below may be performed by an electronic device (e.g., the electronic device 300 of FIG. 3). For example, the electronic device may include at least one processor (e.g., the processor 310 of FIG. 3) and a memory (e.g., the memory 320 of FIG. 3). Operation 430 of FIG. 4 may include operations 810 and 820 below.

In operation 810, based on at least one pattern associated with a first pattern entry type allocated to a first IC among one or more ICs, the electronic device may determine at least one pruned kernel by pruning weights of a first kernel corresponding to the first IC.

For example, FIG. 8 shows first kernels 81 and 82 corresponding to a first IC IC1 among the one or more ICs of a convolutional layer including two OCs OC1 and OC2. As described above with reference to FIG. 7, the first pattern entry type (a 6-entry type) may be allocated to the first IC IC1.

The electronic device may determine at least one pruned kernel 87 by pruning weights of the first kernels 81 and 82 based on at least one pattern 83, 84, 85, or 86 associated with the first pattern entry type (a 6-entry type). The electronic device may prune the weights of the first kernels 81 and 82 by determining an inner product of the first kernels 81 and 82 and the at least one pattern 83, 84, 85, or 86.

In operation 820, the electronic device may determine a pruning score for each of at least one pattern associated with the first pattern entry type, based on weights of each of the at least one pruned kernel.

The electronic device may determine a pruning score S through Equation 2 below, for example.

$${S}_{P} = {\sum }_{j = 0}^{O utput channel} {\sum }_{i = 0}^{{k}^{2}} \vert {W}_{( i , j )} \cdot {P}_{( i , j )} \vert \qquad Equation 2$$

In Equation 2, P denotes a pattern, W·P denotes each element of the inner product result of the kernels and a pattern, and k denotes a size k×k of the kernels.

The electronic device may determine a pruning score for each of the at least one pattern 83, 84, 85, or 86 based on the weights of each of the at least one pruned kernel 87. The pruning score for each of the at least one pattern 83, 84, 85, or 86 may be determined as the sum of the absolute values of elements of pruned kernels corresponding to each pattern of the at least one pruned kernel 87.

When the convolutional layer includes OCs, the pruning score for each of the at least one pattern 83, 84, 85, or 86 may be determined as the sum of the absolute values of the elements of pruned kernels for each OC corresponding to each pattern of the at least one pruned kernel 87. Accordingly, the electronic device may determine the pruning scores for the patterns 83, 84, 85, and 86 as 13, 15, 16, and 13, respectively. For example, the pruning score for the at least one pattern 83 may be determined as a total sum 13 of a sum |−1|+|2|+|1|+|1|+|−2|+|1| of the absolute values of the elements of the pruned kernels corresponding to the OC OC1 and a sum |1|+|1|+|1|+|1|+|1| of the absolute values of the elements of the pruned kernels corresponding to the OC OC2.

The electronic device may determine a pattern having the highest pruning score of the at least one pattern associated with the first pattern entry type to be a first target pattern of the first IC.

The electronic device may determine a pattern 85 having the highest pruning score of the at least one pattern 83, 84, 85, or 86 to be the first target pattern of the first IC IC1.

The electronic device may determine a target pattern for each of the one or more ICs based on the pruning score.

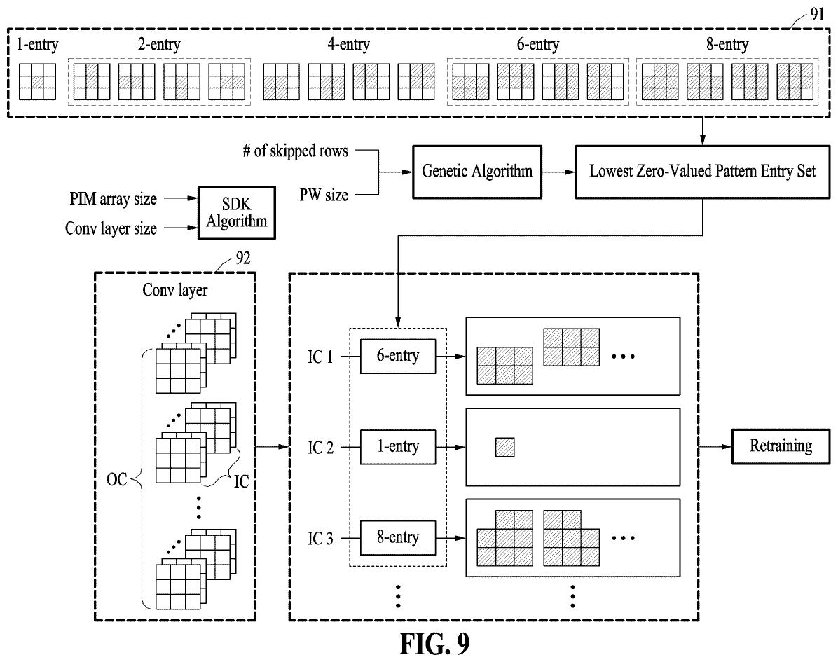

FIG. 9 illustrates an example of a pattern-based pruning method.

An electronic device (e.g., the electronic device 300 of FIG. 3) may obtain at least one pattern 91 associated with a predetermined pattern entry type. A pattern entry type may include a 1-entry type, a 2-entry type, a 4-entry type, and an 8-entry type. At least one pattern associated with a certain pattern entry type may have the same entry. For example, 4 patterns associated with a 2-entry type may be different patterns having 2 entries.

The electronic device may obtain a convolutional layer 92 (or a kernel included in the convolutional layer) of a pre-trained CNN model. The convolutional layer may include at least one IC corresponding to each of at least one channel of an input feature map and at least one OC.

The electronic device may determine the size of a parallel window based on the size of a PIM array for convolution operation, the size of the convolutional layer (or the size of kernels), and the size of the input feature map that is input to the convolutional layer. The electronic device may determine the size of the parallel window using an SDK algorithm model. The SDK algorithm model may be pre-trained to determine the size of the parallel window that minimizes the number of cycles, based on the size of the PIM array, the size of the convolutional layer, and the size of the input feature map.

In the convolution operation, the electronic device may determine a pattern entry set based on the target number of rows to be skipped in the PIM array and the size of the parallel window. The electronic device may determine the pattern entry set that may be used for row-skipping by the target number, using a GA model. The GA model may be pre-trained to determine the pattern entry set that may least prune weight elements of the kernels, based on the target number and the size of the parallel window.

The pattern entry set may include at least one pattern entry type. The at least one pattern entry type may include at least one of a 1-entry type, a 2-entry type, a 4-entry type, or an 8-entry type.

The electronic device may allocate each of the at least one pattern entry type included in the pattern entry set to each of one or more ICs of the kernels included in the convolutional layer. The electronic device may determine the importance of each of the one or more ICs based on weights of the kernels. The electronic device may allocate each of the at least one pattern entry type to each of the one or more ICs of the kernels, based on the importance. With respect to a method of allocating a pattern entry type to an IC, repeated descriptions provided with reference to FIG. 7 are omitted.

The electronic device may determine a pruning score for each of the at least one pattern associated with a corresponding pattern entry type allocated to each of the one or more ICs, based on the weights of the kernels. The electronic device may determine at least one pruned kernel by pruning the weights of the kernels corresponding to each of the one or more ICs, based on each of at least one pattern associated with the corresponding pattern entry type allocated to the corresponding IC. The electronic device may determine the pruning score for each of the at least one pattern based on weights of each of the at least one pruned kernel. With respect to a method of determining a pruning score, repeated descriptions provided with reference to FIG. 8 are omitted.

The electronic device may determine a target pattern for each of the one or more ICs based on the pruning score.

The electronic device may determine one or more pruned kernels by pruning the weights of the kernels corresponding to each of the one or more ICs, based on the target pattern. The electronic device may obtain an output feature map by performing convolution operation between the input feature map and the one or more pruned kernels. The electronic device may retrain a pre-trained CNN model based on the output feature map.

The electronic devices, processors, memories, electronic device 300, processor 310, and memory 320 described herein, including descriptions with respect to respect to FIGS. 1-9, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-9 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method comprising:
determining a pattern entry set for skipping a target number of rows of a processing-in-memory (PIM) array in convolution operation;
allocating each of one or more pattern entry types comprised in the pattern entry set to each of one or more input channels (ICs) of kernels comprised in a convolutional layer;
determining a pruning score for each of one or more patterns associated with a corresponding pattern entry type allocated to the each of the one or more ICs, based on weights of the kernels; and
determining a target pattern for the each of the one or more ICs based on the pruning score.

2. The method of claim 1, wherein the determining of the pattern entry set for skipping the target number of rows of the PIM array comprises:
determining a size of a parallel window of an input feature map, based on a size of a PIM array for convolution operation, a size of the kernels, and a size of the input feature map that is input to the convolutional layer; and
determining the pattern entry set for minimizing weight pruning of the kernels based on the target number of rows to be skipped in the PIM array and the size of the parallel window.

3. The method of claim 1, wherein the allocating of each of the one or more pattern entry types comprised in the pattern entry set to each of the one or more ICs of the kernels comprises:
determining importance for the each of the one or more ICs of the kernels, based on the weights of the kernels; and
allocating the each of the one or more pattern entry types to the each of the one or more ICs of the kernels, based on the importance.

4. The method of claim 3, wherein a pattern entry type having few entries of the one or more pattern entry types is allocated to a channel with low importance among the one or more ICs.

5. The method of claim 3, wherein a pattern entry type having many entries of the one or more pattern entry types is allocated to a channel with high importance among the one or more ICs.

6. The method of claim 1, wherein the determining of the pruning score for each of the one or more patterns associated with the corresponding pattern entry type allocated to each of the one or more ICs, based on the weights of the kernels, comprises:
based on one or more patterns associated with a first pattern entry type allocated to a first IC among the one or more ICs, determining one or more pruned kernels by pruning weights of a first kernel corresponding to the first IC; and
determining the pruning score for each of the one or more patterns associated with the first pattern entry type, based on weights of each of the one or more pruned kernels.

7. The method of claim 6, wherein the determining of the target pattern for each of the one or more ICs based on the pruning score comprises determining a pattern with a highest pruning score of the one or more patterns associated with the first pattern entry type to be a first target pattern of the first IC.

8. The method of claim 1, wherein the one or more pattern entry types comprises any one or any combination of any two or more of a 1-entry type, a 2-entry type, a 4-entry type, and an 8-entry type.

9. The method of claim 1, wherein the one or more patterns associated with the corresponding pattern entry type has the same entry.

10. The method of claim 1, further comprising obtaining the convolutional layer of a pre-trained convolutional neural network (CNN) model.

11. The method of claim 10, further comprising:
determining one or more pruned kernels by pruning weights of one or more kernels corresponding to each of the one or more ICs, based on the target pattern;
generating an output feature map by performing convolution operation between an input feature map and the one or more pruned kernels; and
retraining the pre-trained CNN model based on the output feature map.

12. A non-transitory computer-readable storage medium storing instructions that, when executed by one or more processors, configure the one or more processors to perform the method of claim 1.

13. An electronic device comprising:
one or more processors configured to:
determine a pattern entry set for skipping a target number of rows of a processing-in-memory (PIM) array in convolution operation;
allocate each of one or more pattern entry types comprised in the pattern entry set to each of one or more input channels (ICs) of kernels comprised in a convolutional layer;
determine a pruning score for each of one or more patterns associated with a corresponding pattern entry type allocated to the each of the one or more ICs, based on weights of the kernels; and
determine a target pattern for the each of the one or more ICs based on the pruning score.

14. The electronic device of claim 13, wherein, for the allocating of each of the one or more pattern entry types, the one or more processors are configured to:
determine importance for the each of the one or more ICs of the kernels, based on the weights of the kernels; and
allocate the each of the one or more pattern entry types to the each of the one or more ICs of the kernels, based on the importance.

15. The electronic device of claim 14, wherein a pattern entry type having few entries of the one or more pattern entry types is allocated to a channel with low importance among the one or more ICs.

16. The electronic device of claim 14, wherein a pattern entry type having many entries of the one or more pattern entry types is allocated to a channel with high importance among the one or more ICs.

17. The electronic device of claim 13, wherein, for the determining of the pruning score for each of the one or more patterns, the one or more processors are configured to:
based on one or more patterns associated with a first pattern entry type allocated to a first IC among the one or more ICs, determine one or more pruned kernels by pruning weights of a first kernel corresponding to the first IC; and
determine the pruning score for each of the one or more patterns associated with the first pattern entry type, based on weights of each of the one or more pruned kernels.

18. The electronic device of claim 17, wherein, for the determining of the target pattern for each of the one or more ICs, the one or more processors are configured to determine a pattern with a highest pruning score of the one or more patterns associated with a first pattern entry type to be a first target pattern of a first IC.

19. The electronic device of claim 13, wherein the one or more pattern entry types comprises any one or any combination of any two or more of a 1-entry type, a 2-entry type, a 4-entry type, and an 8-entry type.

20. A processor-implemented method comprising:
determining pruned kernels by pruning weights of one or more kernels of an input channel (IC) of a convolutional layer, by applying a plurality of patterns of a pattern entry type to each of the one or more kernels;
determining, for each of the patterns, a pruning score based on a sum of absolute values of elements of one or more of the pruned kernels corresponding to the respective pattern;
determining, to be a target pattern of the IC, a pattern among the patterns with a highest pruning score among the pruning scores; and
generating an output feature map by performing a convolution operation between an input feature map and the target pattern.
